(19) United States
(12) Patent Application Publication
(10) Pub. No.: US 2026/0169859 A1
(43) Pub. Date: Jun. 18, 2026

(54) MULTI-DOMAIN INTEGRATED CONTROLLER USING MULTI-CORE AND A METHOD PERFORMED IN THE MULTI-CORE BASED MULTI-DOMAIN INTEGRATED CONTROLLER

(71) Applicant: HYUNDAI AUTOEVER CORP., Seoul (KR)

(72) Inventor: Byung Jin Min, Seoul (KR)

(73) Assignee: HYUNDAI AUTOEVER CORP., Seoul (KR)

(21) Appl. No.: 19/416,729

(22) Filed: Dec. 11, 2025

(30) Foreign Application Priority Data
Dec. 17, 2024 (KR) 10-2024-0187856

(51) Int. Cl. G06F 11/14; G06F 12/14

(52) U.S. Cl. CPC G06F 11/1441; G06F 12/1458; G06F 2212/1052

(57) ABSTRACT

A multi-domain integrated controller using a multi-core microcontroller includes a plurality of cores configured to control a plurality of domains, respectively. The multi-domain integrated controller also includes a platform core configured to manage faults occurring in any one of the plurality of domains or shared resources. The plurality of cores includes a first core configured to control a first domain. The platform core is configured to, based on detecting a fault associated with the first domain, control a reset process to be performed for the first core.

### CROSS-REFERENCE TO RELATED APPLICATION

This application claims the benefit of and priority to Korean Patent Application No. 10-2024-0187856 filed on Dec. 17, 2024, the entire contents of which are hereby incorporated herein by reference.

### TECHNICAL FIELD

The present disclosure relates to a multi-domain integrated controller using multi-core and a method performed in the multi-domain integrated controller.

### BACKGROUND

The statements in this section merely provide background information related to the present disclosure and may not constitute prior art.

As vehicle functions become increasingly complex, many electronic controllers are being mounted in vehicles, and consequently, the number of controllers is continuously increasing. Against this backdrop, development is trending toward integrating multiple domain controllers. In this regard, a multi-domain controller in which multiple microcontroller units (MCUs) are mounted on a printed circuit board (PCB) is known. However, such a method has the problem of high production cost, which reduces economic feasibility and makes it difficult to meet cost-reduction demands required to secure competitiveness.

Functional safety requirements are essential for vehicle controllers, and each domain controller has its own safety requirements. This creates difficulties in the process of configuring a multi-domain integrated controller. For example, in the event of an independent fault in a particular domain, a problem may arise in which other domains unnecessarily transition to a safe mode.

### SUMMARY

Aspects of the present disclosure provide a method that supports a safe operation scheme capable of independently satisfying the safety requirements of each domain in a multi-domain integrated controller.

Aspects of the present disclosure provide a method that satisfy the unique safety requirements of each domain when configuring a multi-domain integrated controller using a multi-core microcontroller.

Aspects of the present disclosure provide a control method in which, when a fault occurs in a specific domain, a reset is performed only for that domain.

Aspects of the present disclosure provide a method that, even in a fault situation, satisfies the required functions of a safe mode while also supporting identification and diagnosis of the cause of the problem.

The objectives of the present disclosure are not limited to those mentioned above. Other objectives not explicitly stated herein should be more clearly understood by those having ordinary skill in the art from the following description.

According to an aspect of the present disclosure, a multi-domain integrated controller using a multi-core microcontroller is provided. The multi-domain integrated controller includes a plurality of cores configured to control a plurality of domains, respectively. The multi-domain integrated controller also includes a platform core configured to manage faults occurring in any one of the plurality of domains or shared resources. The plurality of cores includes a first core configured to control a first domain. The platform core is configured to, based on detecting a fault associated with the first domain, control a reset process to be performed for the first core.

In some embodiments, while the reset process is performed for the first core, cores other than the first core may be configured to operate normally.

In some embodiments, the platform core may be further configured to generate a reset command for the first core, and the first core may be configured to restart in response to the reset command.

In some embodiments, respective dedicated memory regions may be allocated for respective cores among the plurality of cores. The platform core may be further configured to, based on detecting the fault associated with the first domain, control a dedicated memory region of the first core to be initialized.

In some embodiments, the platform core may be further configured to update a reset count of the first domain after completion of the reset process for the first core.

In some embodiments, respective dedicated memory regions may be allocated for respective cores among the plurality of cores, and access rights may be granted for the respective dedicated memory regions allocated to the respective cores among the plurality of cores.

In some embodiments, the platform core may be further configured to, based on detecting an attempt by the first core to access a dedicated memory region without the access rights, control the reset process to be performed for the first core.

In some embodiments, the plurality of cores may be configured to access the shared resources via an inter-core interface.

According to the aforementioned and other embodiments of the present disclosure, a multi-domain integrated controller using a multi-core microcontroller is provided. The multi-domain integrated controller includes a plurality of cores configured to control a plurality of domains, respectively. The multi-domain integrated controller also includes a platform core configured to manage a fault occurring in any one of the plurality of cores or shared resources. The platform core is configured to detect the fault and execute one of preset safe modes according to a type of the fault.

In some embodiments, the platform core may be configured to execute a first safe mode based on detecting a first-type fault indicating an error related to the shared resources and the platform core.

In some embodiments, when the first safe mode is executed, the platform core may be further configured to maintain a Controller Area Network (CAN) measurement function and a diagnostic communication function.

In some embodiments, the platform core may be configured to execute a second safe mode based on detecting a second-type fault indicating an error related to a first domain among the plurality of domains.

In some embodiments, when the second safe mode is executed, domains other than the first domain may be configured to operate normally.

In some embodiments, when the second safe mode is executed, the platform core may be further configured to maintain a CAN measurement function and a diagnostic communication function.

In some embodiments, the platform core may be configured to execute a third safe mode based on detecting a third-type fault indicating an uncontrollable error of the multi-core microcontroller.

In some embodiments, when the third safe mode is executed, operation of the platform core and all the plurality of cores may be stopped.

According to the aforementioned and other embodiments of the present disclosure, a multi-domain integrated control method using a multi-core microcontroller is provided. The method includes controlling a plurality of domains by using a plurality of cores, respectively. The plurality of domains includes a first domain controlled by a first core among the plurality of cores. The method also includes detecting faults occurring in any one of the plurality of domains or shared resources. The method additionally includes, based on detecting a fault associated with the first domain, controlling, using a platform core, a reset process to be performed for the first core.

In some embodiments, controlling the reset process may include maintaining cores other than the first core to operate normally while the reset process is performed for the first core.

In some embodiments, respective dedicated memory regions may be allocated for respective cores among the plurality of cores, and controlling the reset process may include controlling, by the platform core, a dedicated memory region of the first core to be initialized.

In some embodiments, the method may further include, after completion of the reset process for the first core, updating, by the platform core, a reset count of the first domain.

It should be noted that the effects of the present disclosure are not limited to those described above. Other effects of the present disclosure not mentioned herein should be more clearly understood by those having ordinary skill in the art from the following description.

### BRIEF DESCRIPTION OF THE DRAWINGS

The above and other aspects and features of the present disclosure will become more apparent from the following detailed description taken in conjunction with reference to the accompanying drawings, in which:

FIG. 1 is a diagram illustrating the configuration of a multi-domain integrated controller using multi-core according to an embodiment of the present disclosure;

FIG. 2 is a diagram illustrating the internal hardware configuration of a multi-core microcontroller according to an embodiment of the present disclosure;

FIG. 3 illustrates the software architecture of the multi-core microcontroller according to an embodiment of the present disclosure;

FIGS. 4-6 are diagrams for explaining a configuration for implementing independent operation by domain according to an embodiment of the present disclosure;

FIG. 7 is a flowchart illustrating an operation in which a reset process is executed for a specific core according to an embodiment of the present disclosure;

FIG. 8 is a detailed flowchart illustrating part of the operation of FIG. 7;

FIG. 9 is a flowchart illustrating an operation in which a safe mode is executed according to an embodiment of the present disclosure; and

FIGS. 10A-10E are diagrams illustrating operations in an exemplary safe mode.

### DETAILED DESCRIPTION

Hereinafter, embodiments of the present disclosure are described in detail with reference to the accompanying drawings. Advantages and features of the present disclosure and methods of accomplishing the same should be more clearly understood from the following detailed description taken in conjunction with the accompanying drawings. The present disclosure may, however, be embodied in many different forms and should not be construed as being limited to the embodiments set forth herein. Rather, these embodiments are provided to make the present disclosure thorough and complete and will fully convey the concept of the present disclosure to those having ordinary skill in the art, and the present disclosure is defined only by the appended claims.

In adding reference numerals to the components of each drawing, it should be noted that the same reference numerals are assigned to the same components as much as possible even when the components are shown in different drawings. In addition, in describing the present disclosure, where it was determined that the detailed description of the related well-known configuration or function would obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries should not be ideally or excessively interpreted unless they are specifically defined otherwise herein. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are used merely to distinguish the components from other components, and the nature or order of the components is not limited by the terms. If a component is described as being “connected,” “coupled” or “contacted” to another component, the component may be directly connected to or contacted with the other component, but it should be understood that another component also may be “connected,” “coupled” or “contacted” between the two components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

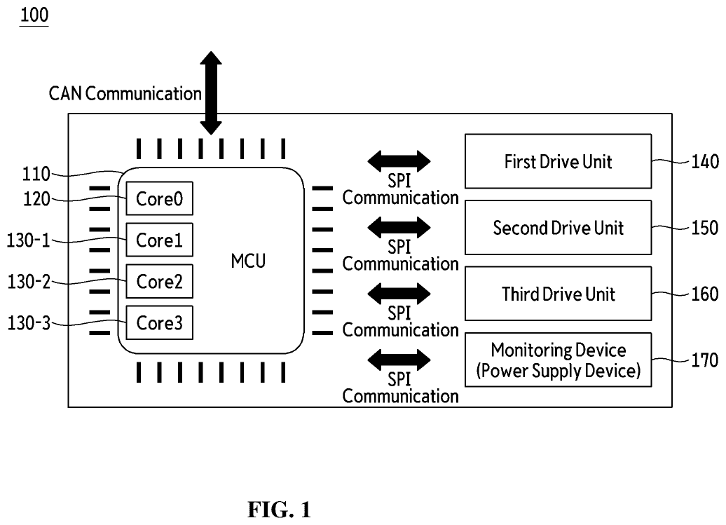

FIG. 1 is a diagram illustrating the configuration of a multi-domain integrated controller using multi-core according to an embodiment of the present disclosure.

Referring to FIG. 1, a multi-domain integrated controller 100 may include a microcontroller unit (MCU) 110 including multi-core, a plurality of drive units 140, 150, and 160, that generate drive signals for controlling respective domains, and a power supply device 170, that supplies operating power to the MCU 110 and the plurality of drive units 140, 150, and 160. In various embodiments, the term “domain” refers to a specific control target, function, or area within a vehicle, and may include not only physical components such as an engine, transmission, airbag, and headlamp, but also functional areas such as driving performance, safety functions, and lighting control. Each domain has safety requirements defined according to its own operating conditions and role, and in the event of a fault, a different safe mode defined for each domain may be applied.

In an embodiment, the MCU 110 may include a plurality of cores configured to control respective domains, and a platform core. For example, the MCU 110 may include a first core 130-1 for controlling a first domain, a second core 130-2 for controlling a second domain, a third core 130-3 for controlling a third domain, and a platform core 120 configured to manage the first, second, and third cores 130-1, 130-2, and 130-3 and shared resources. However, the present disclosure is not limited thereto. For example, more cores may be included depending on the number of domains.

In an embodiment, the plurality of drive units 140, 150, and 160 may include a first drive unit 140 for driving the first domain, a second drive unit 150 for driving the second domain, and a third drive unit 160 for driving the third domain. However, the present disclosure is not limited thereto. For example, more drive units may be included depending on the number of domains.

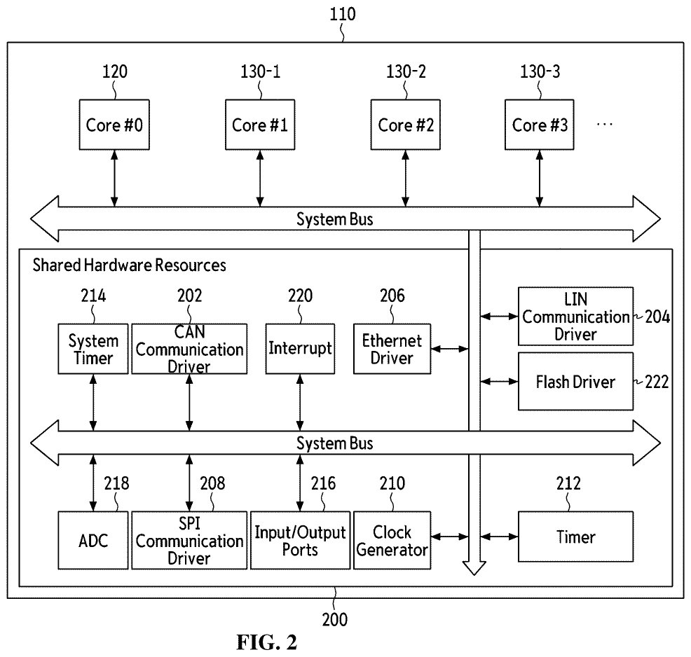

Hereinafter, with reference to FIGS. 2-6, the configuration of a multi-core MCU according to an embodiment of the present disclosure is described in more detail.

FIG. 2 is a diagram illustrating the internal hardware configuration of a multi-core microcontroller according to an embodiment of the present disclosure.

Referring to FIG. 2, the MCU 110 may include a plurality of cores 120, 130-1, 130-2, and 130-3, and shared resources 200. The shared resources 200 may be connected to the plurality of cores 120, 130-1, 130-2, and 130-3 via a system bus. As described with reference to FIG. 1, the plurality of cores 120, 130-1, 130-2, and 130-3 may include the first core 130-1 for controlling the first domain, the second core 130-2 for controlling the second domain, the third core 130-3 for controlling the third domain, and the platform core 120 configured to manage the first, second, and third cores 130-1, 130-2, and 130-3 and the shared resources 200.

The shared resources 200 may be hardware resources, provided in the MCU 110, that may be commonly accessed and used by the first, second, and third cores 130-1, 130-2, and 130-3. The shared resources 200 may include, for example, a Controller Area Network (CAN) communication driver 202, a Local Interconnect Network (LIN) communication driver 204, and an Ethernet driver 206 for communication with an external device, a Serial Peripheral Interface (SPI) communication driver 208 for communication between the MCU 110 and the first, second, and third drive units 140, 150, and 160 or the power supply device 170, a clock generator 210, a timer 212, and a system timer 214 for generating time information, input/output ports 216 for signal input and processing, an analog-to-digital converter (ADC) 218, an interrupt 220, and a flash driver 222 for data storage. These are merely examples of the shared resources 200, and components may be added or omitted as needed.

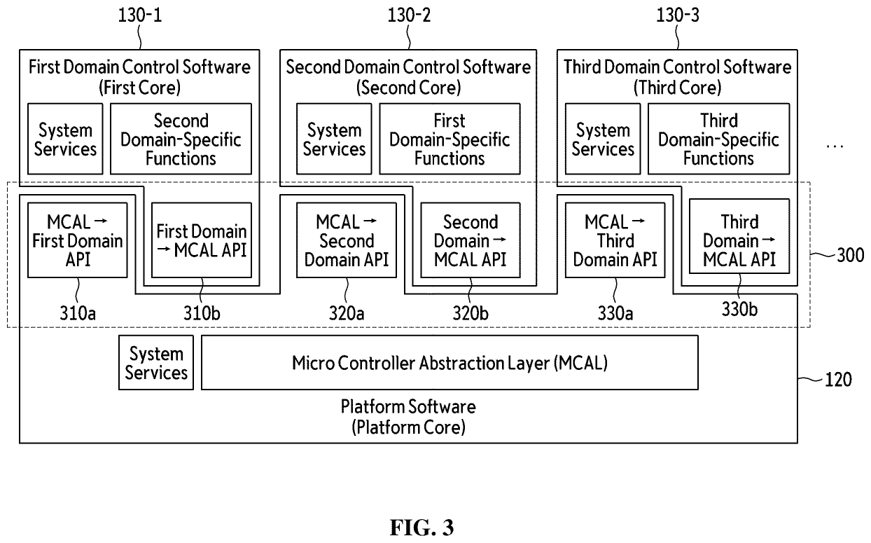

When a single shared resource is used by multiple domains in this manner, problems such as resource access conflicts or reduced efficiency may occur. Accordingly, in embodiments of the present disclosure, the platform core 120, which controls and manages the shared resources 200, may be used to ensure efficient and stable use of the shared resources 200, thereby improving overall system stability and performance. This is described in more detail below with reference to FIG. 3.

FIG. 3 illustrates the software architecture of the multi-core microcontroller according to an embodiment of the present disclosure.

Referring to FIG. 3, the first core 130-1 may include first domain control software for controlling the first domain, the second core 130-2 may include second domain control software for controlling the second domain, and the third core 130-3 may include third domain control software for controlling the third domain. The first domain control software, second domain control software, and third domain control software may each include, as sublayers, system services and domain-specific functions. In various embodiments, the system services may refer to an operating system (OS) for operating the MCU 110 or refer to tasks that need to be performed for each domain.

The platform core 120 may include platform software, and the platform software may include system services and a microcontroller abstraction layer (MCAL). The MCAL provides an interface between hardware and upper-level software and controls the shared resources 200 provided in the MCU 110. In an embodiment, the MCAL may be software designed based on the AUTomotive Open System ARchitecture (AUTOSAR) standard, and may perform the functions of reading and writing registers of the shared resources 200 and handling interrupts. The platform core 120 may further include, in addition to the MCAL, various components of the platform software based on the AUTOSAR standard. For example, the platform core 120 may further include basic software (BSW), an electronic control unit (ECU) abstraction layer, a service layer, and a runtime environment (RTE) for supporting data exchange with application software.

In an embodiment, the domain control software of the first, second, and third cores 130-1, 130-2, and 130-3, and the platform software of the platform core 120 may be connected via an inter-core interface 300. The inter-core interface 300 may include an application interface (API). For example, the first, second, and third cores 130-1, 130-2, and 130-3 may each include a unidirectional API, and the platform core 120 may include a corresponding paired API for each of the APIs of the first, second, and third cores 130-1, 130-2, and 130-3.

In an embodiment, the first core 130-1 and the platform core 120 may interact through a MCAL→First Domain API interface 310a and a First Domain→MCAL API interface 310b. Similarly, the second core 130-2 and the platform core 120 may interact through an MCAL→Second Domain API interface 320a and a Second Domain→MCAL API interface 320b. Similarly, the third core 130-3 and the platform core 120 may interact through an MCAL→Third Domain API interface 330a and a Third Domain→MCAL API interface 330b.

In this manner, the first, second, and third cores 130-1, 130-2, and 130-3 may be connected to the shared resources 200 in the MCU 110 via the platform core 120. In addition, the first, second, and third cores 130-1, 130-2, and 130-3 may also be connected to one another via the platform core 120. In other words, the first, second, and third cores 130-1, 130-2, and 130-3 may access the shared resources 200 or interact with one another via the platform core 120.

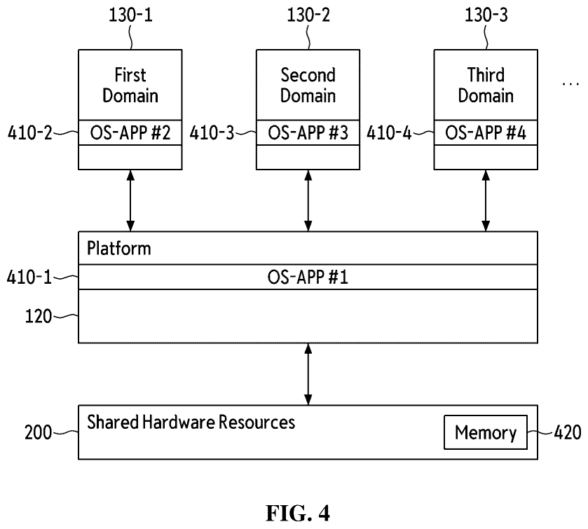

As described above, when a plurality of cores controls different domains, it is beneficial to ensure independent operation of each domain. In particular, each domain has distinct false-response strategies and safety requirements, making it highly important to maintain independence so that measures taken for a fault in one domain do not affect another domain. Accordingly, the embodiments of present disclosure provides an environment for implementing independent safe operation by domain. This is described in more detail with below reference to FIGS. 4-7 . For reference, in the accompanying drawings, domains are illustrated separately to highlight domain-specific configurations, but it should be understood that a first domain corresponds to a first core, a second domain corresponds to a second core, and a third domain corresponds to a third core. In addition, in the following description, the same reference numerals as those used in FIGS. 1-3 are used for the configurations of the first, second, and third domains.

FIG. 4 is a diagram for explaining a configuration for implementing independent operation by domain according to an embodiment of the present disclosure.

As illustrated in FIG. 4, to ensure independent operation by domain, OS applications are separated to provide an independent execution environment for each domain. In an embodiment, each of the OS applications refers to a collection of OS objects supported by the AUTOSAR OS, and may include a task, interrupt service routine (ISR), counter, alarm, and schedule table.

For example, a first OS application (OS-APP #1) 410-1 may be assigned to the platform core 120, and a second OS application (OS-APP #2) 410-2 may be assigned to the first core 130-1 corresponding to the first domain. In addition, a third OS application (OS-APP #3) 410-3 may be assigned to the second core 130-2 corresponding to the second domain, and a fourth OS application (OS-APP #4) 410-4 may be assigned to the third core 130-3 corresponding to the third domain.

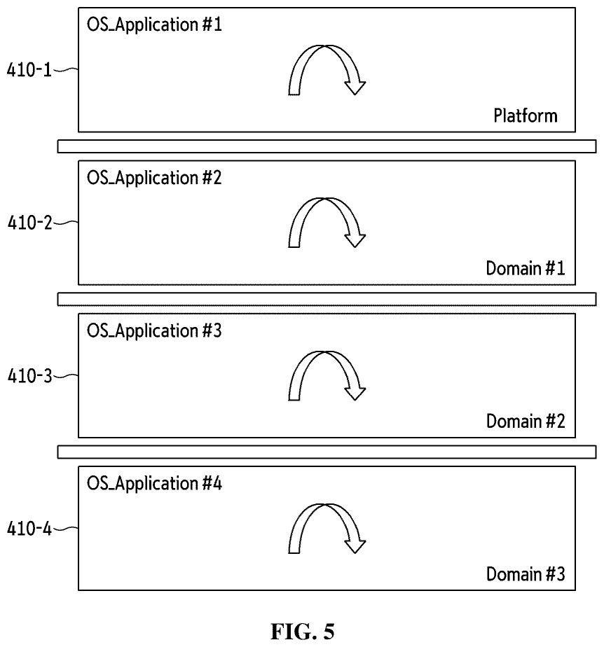

In this manner, since the OS applications are separated for the platform core 120 and for each of the first, second, and third domains, independent operation of each domain may be ensured. In an embodiment, by separating the OS application, each domain operates independently, and an event such as a fault or restart in one domain does not affect another domain (see FIG. 5). For example, even when the second OS application (OS-APP #2) 410-2 is restarted, the third OS application (OS-APP #3) 410-3 assigned to the second domain and the fourth OS application (OS-APP #4) 410-4 assigned to the third domain continue to operate normally. This independent structure prevents interference between domains, maintains system stability, and, through fault isolation, allows each domain to satisfy its own functions and safety requirements. For example, when a fault occurs in a particular domain, a reset may be performed only for that domain, without affecting operation of other domains.

In an embodiment, functions related to maintaining system stability, such as fault detection, management, and reset, may be performed by the platform core 120. Specifically, the platform core 120 may perform management of faults occurring in multiple domains and the shared resources 200. For example, when a fault associated with a specific domain occurs, the platform core 120 may control a reset process to be performed for the core corresponding to the specific domain. In another example, the platform core 120 may detect a fault occurring in any one of the first, second, and third domains or shared resources 200, and may execute one of preset safe modes according to the type of the detected fault. This is described in greater detail below.

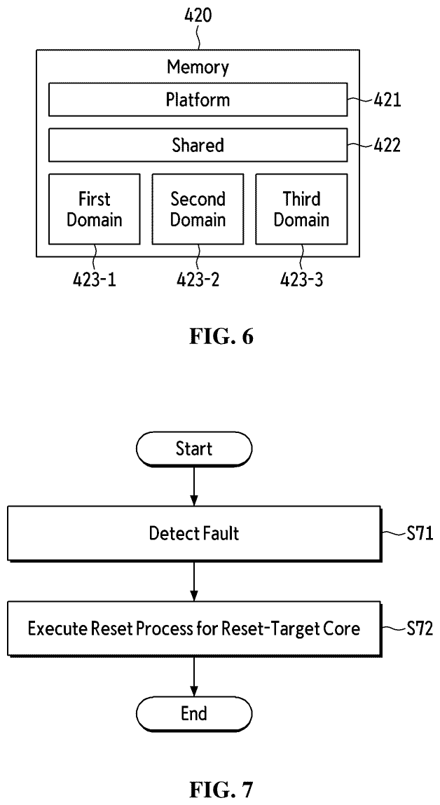

In an embodiment, to ensure independent operation by domain, the memory of each domain also needs to be physically or logically separated. Separation of memory by domain enables each domain to securely manage its own data and resources, and plays an important role in protecting against unintended access to data of other domains. This is described in more detail below with reference to FIG. 6.

As illustrated in FIG. 6, a memory 420 may be separated into a platform-dedicated memory 421, a shared memory 422, a dedicated memory 423-1 for the first domain, a dedicated memory 423-2 for the second domain, and a dedicated memory 423-3 for the third domain. In other words, a dedicated memory region may be allocated for each of the platform core 120 and the first, second, and third cores 130-1, 130-2, and 130-3. Along with separating the memory 420, access rights may be assigned so that each OS application may access only the memory regions it requires. For example, the second OS application (OS-APP #2) 410-2 for the first domain may access only its own code and data region, and may not access the memory region allocated to the second or third domain.

In this manner, by separating memory by domain and restricting inter-domain memory access, it is possible to prevent a fault or abnormal operation occurring in a particular domain from affecting the data integrity or performance of other domains. In addition, since each domain can operate independently in its own memory region, memory contention and data loss can be prevented.

In an embodiment, memory access control by domain may be performed through the platform core 120, thereby enabling efficient control and management of memory access between domains. Specifically, the platform core 120 may manage information on memory access permissions for each domain and, based thereon, ensure that only memory access requests for allowed regions are performed. In particular, when an attempt to access a memory region without access rights is detected, the platform core 120 may take appropriate measures. This is described in greater detail below.

In the examples described with reference to FIGS. 4-6, one core is allocated for each domain, and one OS application is allocated for each domain. However, the present disclosure is not limited thereto. In some embodiments, two or more cores may be allocated for one domain, and two or more OS applications may also be allocated for one domain.

Thus far, the configuration and functions of the multi-domain integrated controller according to an embodiment of the present disclosure have been described with reference to FIGS. 1-6. The aforementioned embodiments may be understood in more detail by reference to other embodiments to be described below. In addition, the technical idea understood from the above embodiments may be reflected in other embodiments described below even if not expressly stated.

Hereinafter, with reference to FIG. 7 and subsequent drawings, operations performed for safe operation in a multi-domain integrated controller according to some embodiments of the present disclosure are described in detail. Unless otherwise mentioned, steps or operations described in some of the flowcharts below are assumed to be performed by the platform core 120 as described with reference to FIGS. 1-6. However, in an actual environment, some steps or operations of methods described below may be performed by another core or by another computing device.

First, an operation in which a reset process is executed for a specific core, according to an embodiment, is described with reference to FIG. 7.

FIG. 7 is a flowchart illustrating an operation in which a reset process is executed for a specific core according to an embodiment of the present disclosure. However, this is merely an example, and some steps or operations may be added and/or deleted as needed. In addition, although the subject of each step or operation may be a platform core, a description thereof may be omitted for convenience.

Referring to FIG. 7, in a step or operation S71, a fault occurring in any one of a plurality of domains or shared resources may be detected. For example, by existing hardware-based and/or software-based fault detection mechanisms, a fault occurring in the plurality of domains and shared resources may be detected, and such detected fault information may be collected at the platform core and analyzed.

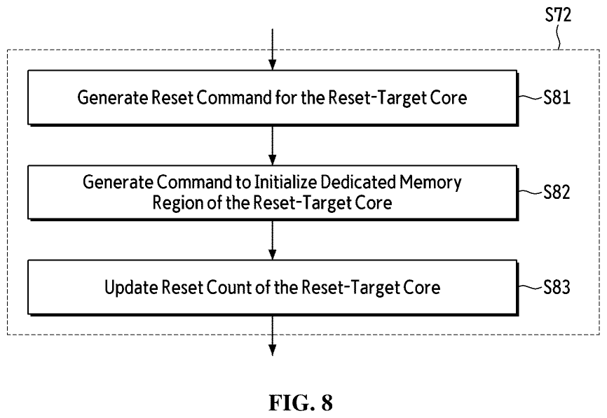

As a result of analyzing the detected fault information, when it is determined that a fault associated with a specific domain has occurred and that the fault satisfies a reset criterion for the specific domain, in a step or operation S72, a reset process may be executed for a reset-target core. In an embodiment, the reset-target core may be the core corresponding to the specific domain, where the fault has occurred. For example, when a fault associated with a first domain occurs, a reset process may be performed for a first core that controls the first domain. This is described in further detail below with reference to FIG. 8.

FIG. 8 is a detailed flowchart illustrating part of the operation of FIG. 7.

Referring to FIG. 8, in a step or operation S81, a reset command for the reset-target core may be generated. For example, when a fault associated with the first domain occurs, a reset command for the first core may be generated, and in this case, the first core may be restarted in response to the reset command. For example, when the reset command is delivered from the platform core, the OS application of the first core may activate a restart function to perform a recovery procedure. In this process, the OS application of the first core may suspend a currently running task, restore system settings, and be restored to an initial state, while not affecting the operation of other cores or domains. Accordingly, while the reset process is performed for the first core, the remaining cores other than the first core may continue to operate normally, thereby achieving a partial reset effect in which only the first core among the plurality of cores is reset.

In a step or operation S82, a command to initialize the dedicated memory region of the reset-target core may be generated. For example, when a fault associated with the first domain occurs, an initialization command may be delivered for the dedicated memory region of the first core. As a result, the dedicated memory region of the first core may be initialized so that data corrupted due to the fault is removed and an initial state for stable operation is restored.

In a step or operation S83, the reset count of the reset-target core may be updated. Specifically, when a reset process is performed for the first core, after the reset process is completed, the reset count of the first domain may be updated. The platform core may manage reset histories for each domain, thereby identifying problems that occur repeatedly in a specific domain.

In an embodiment, such a partial reset for a specific domain may be performed not only when a fault associated with the specific domain occurs, but also when an attempt by the specific domain to access a memory region without access rights is detected. As described above, a dedicated memory region is allocated for each of the plurality of cores, and each core may be granted access rights only for its allocated memory region. In an embodiment, when the platform core detects, at a specific core, an attempt to access a memory region for which the specific core has no access rights, the platform core may control a reset process to be performed for the specific core. For example, when an attempt by the first core to access a memory region without access rights is detected, the platform core may control a reset process to be performed for the first core. For the reset process, details are as provided above.

As described above with reference to FIGS. 7 and 8, operations have been described in detail in which, when only a specific domain (or core) requires reset due to occurrence of a fault or the like, a reset process is performed for the specific domain (or core). Hereinafter, a method for operating a safe mode in the multi-domain integrated controller according to an embodiment of the present disclosure is described in more detail.

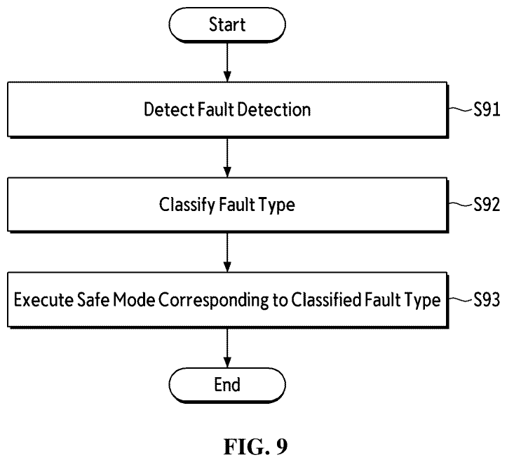

FIG. 9 is a flowchart illustrating an operation in which a safe mode is executed according to an embodiment of the present disclosure. It should be understood that this is merely an example, and that some steps or operations may be added and/or deleted as needed. In addition, although the actor of each step or operation may be a platform core, description thereof may be omitted for convenience.

Referring to FIG. 9, in a step or operation S91, a fault occurring in any one of a plurality of domains (or cores) or shared resources may be detected. For example, by existing hardware-based and/or software-based fault detection mechanisms, a fault occurring in any one of the plurality of domains (or cores) or shared resources may be detected, and the detected fault information may be collected at the platform core and analyzed.

As a result of analyzing the detected fault information, in a step or operation S92, the detected fault may be classified as one of the preset fault types, and in a step or operation S93, a safe mode corresponding to the classified fault type may be executed.

For example, when a first-type fault indicating an error related to the shared resources and the platform core is detected, a first safe mode may be executed. When the first safe mode is executed, only minimum functions of the platform core may operate. For example, where a CAN measurement function and a diagnostic communication function are provided in the platform core, the CAN measurement function and the diagnostic communication function may be maintained when the first safe mode is executed. As a result, even in a fault state, data necessary for cause analysis and identification may be acquired through the CAN measurement function and the diagnostic communication function.

In another example, when a second-type fault indicating an error related to the first domain, which is one of the plurality of domains, is detected, a second safe mode may be executed. When the second safe mode is executed, domains other than the first domain may continue to operate normally, and the CAN measurement function and the diagnostic communication function may be maintained via the platform core. In this case, the first domain where the fault has occurred is switched to its safe-mode state, and as a result, operation of the first domain may be changed so that the first domain is disabled or only some limited functions are maintained.

In yet another example, when a third-type fault indicating an uncontrollable error of the multi-core microcontroller is detected, a third safe mode may be executed. When the third safe mode is executed, the operation of the platform core and all cores may be stopped, in which case only boot software may operate so that reprogramming may be performed.

In this manner, according to an embodiment, even after entering a safe mode, the platform core may maintain operation of the CAN measurement function and the diagnostic communication function, and thus, even in a fault situation, the system state may be monitored, a fault diagnosis history may be obtained, and the cause of the problem may be analyzed. In addition, even where a particular domain is switched to a safe-mode state, the platform core may retain control over each domain and may control other domains to continue to operate normally. Accordingly, it is possible to support meeting the safety requirements of each domain and, by preventing interference between domains, ensure the stability and reliability of the multi-domain integrated controller according to an embodiment of the present disclosure.

In some embodiments, different safe modes may be set depending on the number and type of domains applied to the multi-domain integrated controller according to an embodiment of the present disclosure. Hereinafter, example definitions of various safe modes and operations according to the respective safe modes are described in more detail, taking, as an example, a multi-core microcontroller composed of a first domain (or first core), a second domain (or second core), a third domain (or third core), a platform core, and shared resources, as illustrated in FIG. 4.

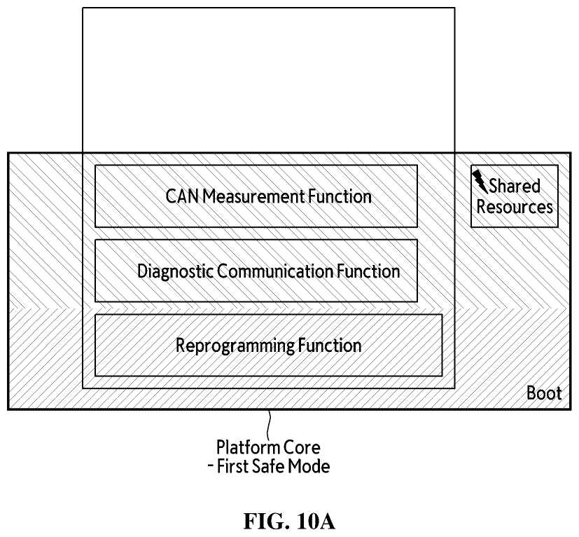

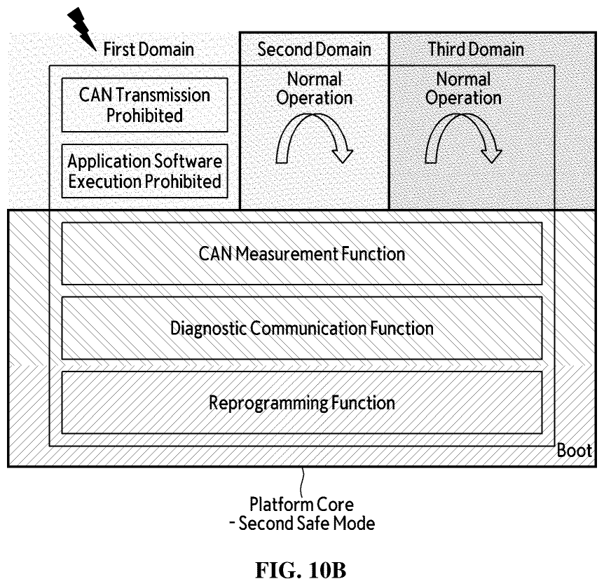

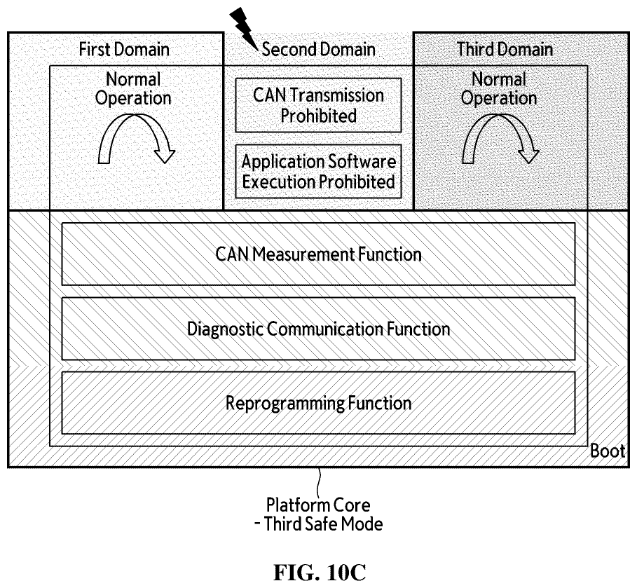

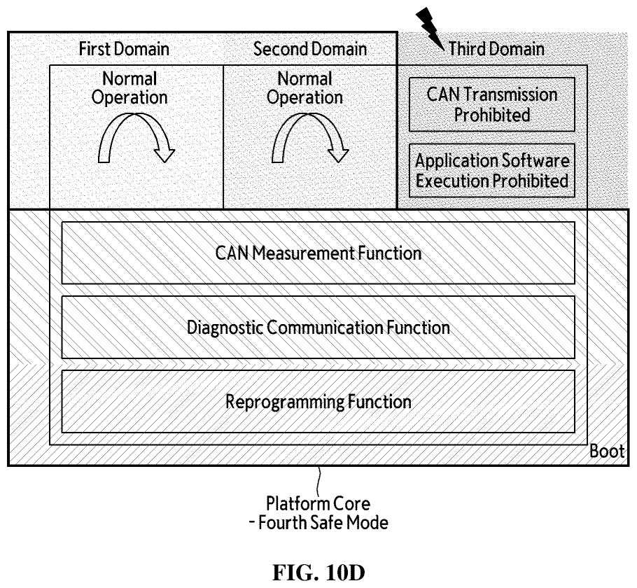

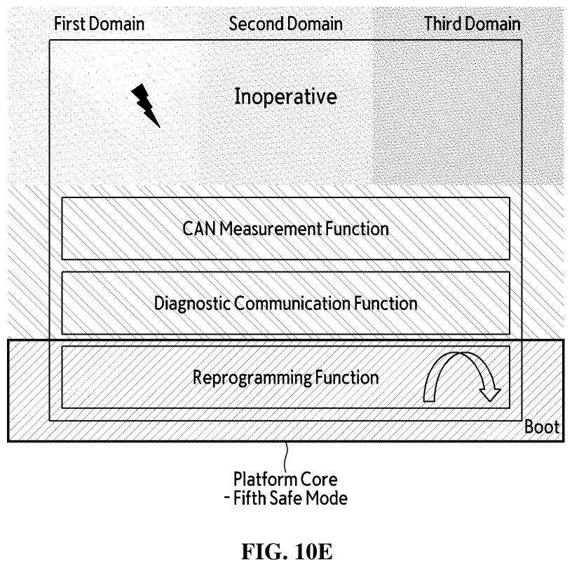

FIGS. 10A-10E are diagrams illustrating operations in an example safe mode.

Referring to FIG. 10A, which is a diagram illustrating operation when a first safe mode is executed, when an error related to the shared resources and/or the platform core occurs so as to affect the entire system, the first safe mode may be executed. In this case, only minimum functions of the platform core may operate and, specifically, the CAN measurement function and the diagnostic communication function may be maintained.

Referring to FIG. 10B, which is a diagram illustrating operation when a second safe mode is executed, when an error related to the first domain occurs, the second safe mode may be executed. In this case, the software of domains other than the first domain may operate normally, while, in the first domain, CAN transmission is prohibited and execution of application software may be stopped.

Referring to FIG. 10C, which is a diagram illustrating operation when a third safe mode is executed, when an error related to the second domain occurs, the third safe mode may be executed. In this case, the software of domains other than the second domain may operate normally, while, in the second domain, CAN transmission is prohibited and execution of application software may be stopped.

Referring to FIG. 10D, which is a diagram illustrating operation when a fourth safe mode is executed, when an error related to the third domain occurs, the fourth safe mode may be executed. In this case, the software of domains other than the third domain may operate normally, while, in the third domain, CAN transmission is prohibited and execution of application software may be stopped.

Referring to FIG. 10E, which is a diagram illustrating operation when a fifth safe mode is executed, when an uncontrollable error of the multi-core microcontroller occurs, the fifth safe mode may be executed. In this case, only boot software may operate, the operation of the platform core and all domains may be stopped, and only reprogramming may be performed.

So far, a variety of embodiments of the present disclosure and the effects according to embodiments thereof have been described with reference to FIGS. 1-10E. The effects according to the technical idea of the present disclosure are not limited to the forementioned effects. Other unmentioned effects not mentioned herein should be more clearly understood by those having ordinary skill in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Those having ordinary skill in the art should appreciate that many variations and modifications can be made to the embodiments described herein without departing from the principles of the present disclosure. Therefore, the described embodiments of the present disclosure are used in a generic and descriptive sense only and not for purposes of limitation.

What is claimed is:

1. A multi-domain integrated controller using a multi-core microcontroller, the multi-domain integrated controller comprising:
a plurality of cores configured to control a plurality of domains, respectively; and
a platform core configured to manage faults occurring in any one of the plurality of domains or shared resources,
wherein:
the plurality of cores includes a first core configured to control a first domain, and
the platform core is configured to, based on detecting a fault associated with the first domain, control a reset process to be performed for the first core.

2. The multi-domain integrated controller of claim 1, wherein, while the reset process is performed for the first core, cores other than the first core are configured to operate normally.

3. The multi-domain integrated controller of claim 1, wherein:
the platform core is further configured to generate a reset command for the first core; and
the first core is configured to restart in response to the reset command.

4. The multi-domain integrated controller of claim 1, wherein:
respective dedicated memory regions are allocated for respective cores among the plurality of cores; and
the platform core is further configured to, based on detecting the fault associated with the first domain, control a dedicated memory region of the first core to be initialized.

5. The multi-domain integrated controller of claim 1, wherein the platform core is further configured to, after completion of the reset process for the first core, update a reset count of the first domain.

6. The multi-domain integrated controller of claim 1, wherein:
respective dedicated memory regions are allocated for respective cores among the plurality of cores; and
access rights are granted for the respective dedicated memory regions allocated to the respective cores among the plurality of cores.

7. The multi-domain integrated controller of claim 6, wherein the platform core is further configured to, based on detecting an attempt by the first core to access a dedicated memory region without the access rights, control the reset process to be performed for the first core.

8. The multi-domain integrated controller of claim 1, wherein respective cores, among the plurality of cores, are configured to access the shared resources via an inter-core interface.

9. A multi-domain integrated controller using a multi-core microcontroller, the multi-domain integrated controller comprising:
a plurality of cores configured to control a plurality of domains, respectively; and
a platform core configured to manage a fault occurring in any one of the plurality of cores or shared resources,
wherein the platform core is configured to detect the fault and execute one of preset safe modes according to a type of the fault.

10. The multi-domain integrated controller of claim 9, wherein the platform core is configured to execute a first safe mode based on detecting a first-type fault indicating an error related to the shared resources and the platform core.

11. The multi-domain integrated controller of claim 10, wherein, when the first safe mode is executed, the platform core is further configured to maintain a Controller Area Network (CAN) measurement function and a diagnostic communication function.

12. The multi-domain integrated controller of claim 9, wherein the platform core is configured to execute a second safe mode based on detecting a second-type fault indicating an error related to a first domain among the plurality of domains.

13. The multi-domain integrated controller of claim 12, wherein, when the second safe mode is executed, domains other than the first domain are configured to operate normally.

14. The multi-domain integrated controller of claim 12, wherein, when the second safe mode is executed, the platform core is further configured to maintain a CAN measurement function and a diagnostic communication function.

15. The multi-domain integrated controller of claim 9, wherein the platform core is configured to execute a third safe mode based on detecting a third-type fault indicating an uncontrollable error of the multi-core microcontroller.

16. The multi-domain integrated controller of claim 15, wherein, when the third safe mode is executed, operation of the platform core and all the plurality of cores is stopped.

17. A multi-domain integrated control method using a multi-core microcontroller, the multi-domain integrated control method comprising:
controlling a plurality of domains by using a plurality of cores, respectively, wherein the plurality of domains includes a first domain controlled by a first core of the plurality of cores;
detecting faults occurring in any one of the plurality of domains or shared resources; and
based on detecting a fault associated with the first domain, controlling, using a platform core, a reset process to be performed for the first core.

18. The method of claim 17, wherein controlling the reset process includes maintaining cores other than the first core to operate normally while the reset process is performed for the first core.

19. The method of claim 17, wherein:
respective dedicated memory regions are allocated for respective cores among the plurality of cores; and
controlling the reset process includes controlling, by the platform core, a dedicated memory region of the first core to be initialized.

20. The method of claim 17, further comprising, after completion of the reset process for the first core, updating, by the platform core, a reset count of the first domain.
